(19) United States
(12) Patent Application Publication
(10) Pub. No.: US 2011/0128622 A1
(43) Pub. Date: Jun. 2, 2011

(54) THREE-DIMENSIONAL DISPLAY DEVICE WITH LENS FOR SPLITTING LIGHT ALONG TWO AXES

(75) Inventors: SHENG-CHANG CHEN, Miao-Li County (TW); YU-CHENG LIN, Miao-Li County (TW); YUNG-HSUN WU, Miao-Li County (TW)

(73) Assignee: CHIMEI INNOLUX CORPORATION, Miao-Li County (TW)

(21) Appl. No.: 12/953,477

(22) Filed: Nov. 24, 2010

(30) Foreign Application Priority Data
Nov. 30, 2009 (TW) 98140767

(51) Int. Cl. G02B 27/22

(52) U.S. Cl. 359/464

(57) ABSTRACT

A three-dimensional display device includes a display panel and an optical film. The display panel includes a plurality of display units arranged in a matrix. Each display unit includes a plurality of pixels configured for displaying sub-images having stereoscopic parallax. The optical film includes a plurality of lenses, each corresponding to a respective display unit. The lens is disposed opposite to the corresponding display unit and configured to split light corresponding to two sub-images of the corresponding display unit to reach both left and right viewing sides, respectively.

### BACKGROUND

1. Technical Field

The present disclosure relates to display technology, and more particularly, to a three-dimensional display device having a plurality of lens for splitting light along a parallel axis and a vertical axis.

2. Description of Related Art

In order to provide stereo viewing, a typical three-dimensional display device needs to cooperate with a pair of special glasses such as a pair of so-called shutter glasses. These shutter glasses close a left shutter corresponding to a left-eye of a user when a right image is displayed, while a right shutter corresponding to a right-eye of the user is closed when a left image is displayed, such that the right image and the left image are presented in an alternating manner, and thus, a stereo viewing can be obtained by the user.

However, use of such glasses is inconvenient, so in order to provide the same effect to the naked eye, various autostereopsis display devices have been developed. However, existing autostereopsis display devices requires a sight line of a user to be substantially parallel to a horizontal axis of the display screen. Due to this limited viewing angle, a three-dimensional displaying quality of the existing autostereopsis display device is somewhat low.

What is needed, therefore, is a three-dimensional display device that can overcome the described limitations.

### SUMMARY

An aspect of the disclosure relates to a three-dimensional display device including a display panel and an optical film. The display panel includes a plurality of display units arranged in a matrix, each display unit including a plurality of pixels configured for displaying sub-images having stereoscopic parallax. The optical film is disposed on the display units of the display panel and includes a plurality of lenses. Each of the lenses respectively corresponds to the display units and is configured to split light emitted by the display units along a parallel axis and a vertical axis of the three-dimensional display device.

An aspect of the disclosure relates to a three-dimensional display device including a display panel and an optical film. The display panel includes a plurality of display units arranged in a matrix, and each display unit displays a plurality of sub-images. The optical film is disposed on the display panel, and includes a plurality of lenses each respectively corresponding to the display units. The lens is configured to select two sub-images displayed by the corresponding display unit, the selected sub-images forming a right image corresponding to a right-eye of a user and a left image corresponding to a left-eye.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views, and all the views are schematic.

FIG. 1 is an exploded view of a three-dimensional display device according to a first embodiment of the present disclosure, the three-dimensional display device including a display panel and an optical film.

FIG. 2 is a planar view of the display panel of the display device of FIG. 1, the display panel including a plurality of display units each having pixels.

FIG. 3 is a schematic view of a pyramid to be displayed by the display panel of FIG. 1.

FIG. 4 schematically illustrates an example of a relationship between pyramid images of FIG. 3 captured at different axes and the pixels of the display unit of the display panel of FIG. 2 when the display panel displays the pyramid of FIG. 3.

FIG. 5 is a planar view of the optical film of the three-dimensional display device of FIG. 1, the optical film including a plurality of lenses.

FIG. 6 is a cross-section of the lens of the optical film of FIG. 5, taken from line VII-VII.

FIG. 7 is a cross-section of the lens of the optical film of FIG. 5, taken from line VIII-VIII.

FIGS. 8-10 schematically illustrate optical routes of light from the pixels of the display panel of FIG. 2 and transmitted to a user's eyes.

FIG. 11 is a planar view of a display panel of a three-dimensional display device according to a second embodiment of the present disclosure.

FIG. 12 is a planar view of an optical film of the three-dimensional display device according to the second embodiment of the present disclosure.

FIG. 13 is an exploded view of a three-dimensional display device according to a third embodiment of the present disclosure.

### DETAILED DESCRIPTION

Reference will now be made to the drawings to describe certain exemplary embodiments of the present disclosure in detail.

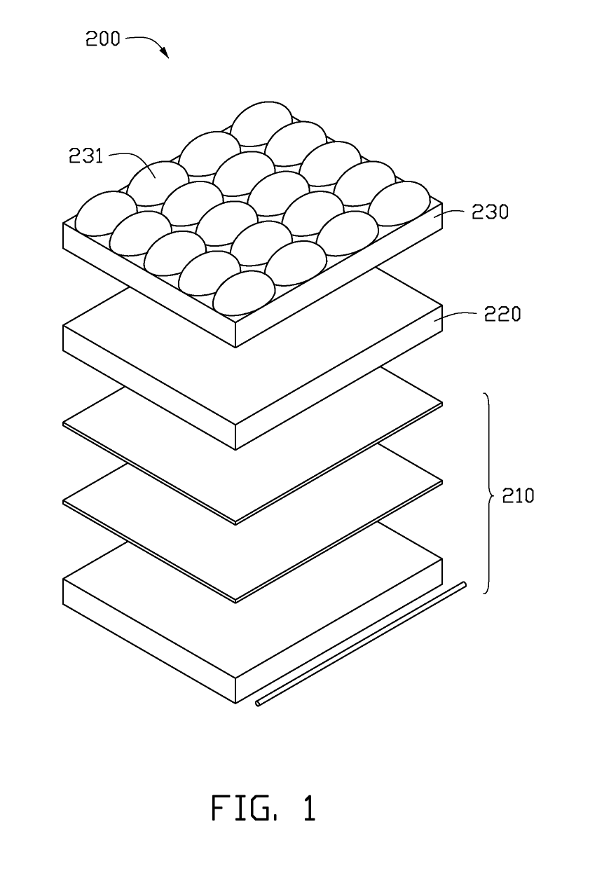

Referring to FIG. 1, a three-dimensional display device 200 according to an embodiment of the present disclosure is shown. The three-dimensional display device 200 includes a display panel 220, a backlight module 210, and an optical film 230. The display panel 220 can be a liquid crystal panel, which includes a top viewing surface and a bottom surface opposite to the viewing surface. The backlight module 210 can be located adjacent to the bottom surface of the display panel 220, and is adapted to illuminate the display panel 220 to display images. The optical film 230 can be located adjacent to the viewing surface of the display panel 220, and is adapted to split light corresponding to images having stereoscopic parallax provided by the display panel 220 to transmit to a left-eye and a right-eye of a user respectively. Accordingly, right image can be provided to the right-eye, and left image can be provided to the left-eye, such that the user experiences a three-dimensional image.

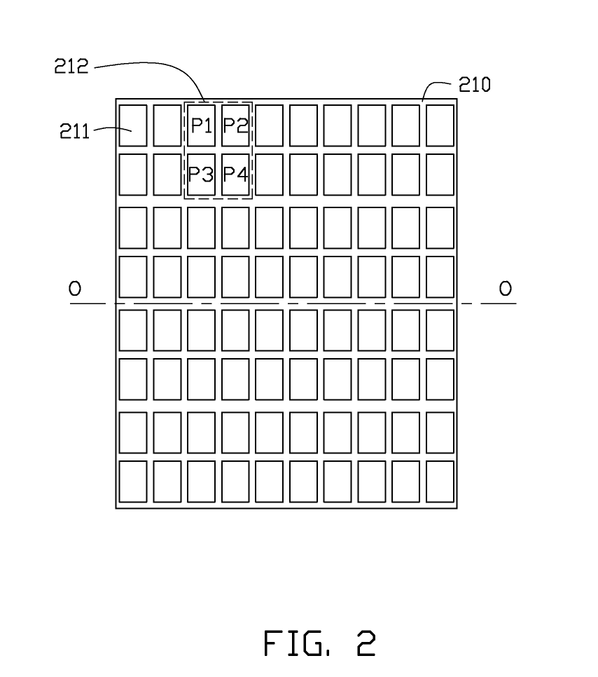

Referring also to FIG. 2, the display panel 220 may include a plurality of display units 212 arranged in a matrix. Each display unit 212 may include m×n pixels 211 positioned as a sub-matrix, where m and n are both integers. In the illustrated embodiment, for example, m and n can both have a value of 2, i.e., m=2, n=2. With the described arrangement, each display unit 212 includes four pixels 211 cooperatively forming a sub-matrix with two rows and two columns. To simplify the description, in the following description of the illustrated embodiment, the four pixels 211 of the display unit 212 are named and labeled as a first pixel P1, a second pixel P2, a third pixel P3, and a fourth pixel P4, respectively located at a top-left corner, a top-right corner, a bottom-left corner, and a bottom-right corner of the sub-matrix, as shown in FIG. 2.

In the illustrated embodiment, the display panel 220 may simultaneously display four images via the display units 212. The four images can be named as a first image, a second image, a third image, and the fourth image. The first image consisting of a plurality of first sub-images is displayed by the first pixels of the display units 212, and each of the first sub-images is displayed by a first pixel P1 of the corresponding display unit 212. The second image consisting of a plurality of second sub-images is displayed by the second pixels of the display units 212, and each of the second sub-images is displayed by a second pixel P2 of the corresponding display unit 212. The third image consisting of a plurality of third sub-images is displayed by the third pixels of the display units 212, and each of the third sub-images is displayed by a third pixel P3 of the corresponding display unit 212. The fourth image consisting of a plurality of fourth sub-images is displayed by the fourth pixels of the display units 212, and each of the sub-images is displayed by a fourth pixel P4 of the corresponding display unit 212. The four images respectively correspond to four pictures of an object captured from four different capture axes. Stereoscopic parallax exists between the four sub-images of each display unit. Accordingly, stereoscopic parallax exists between the four images, and two of the four images can be configured as a right image and a left image at a certain time instant, thus, a cooperation of the two images can provide a stereo viewing effect.

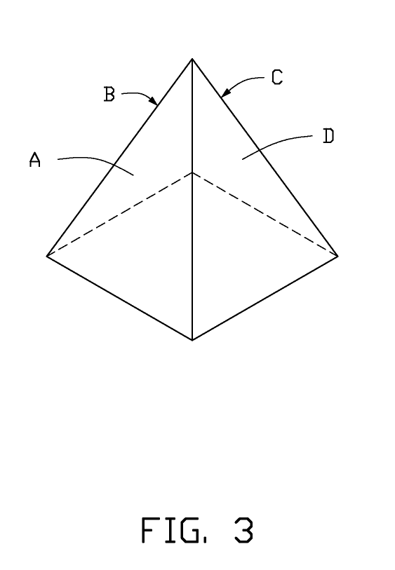

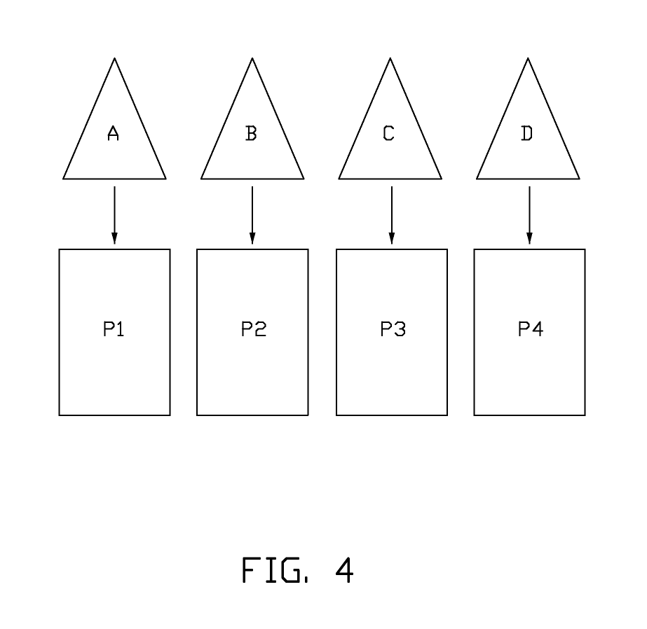

For example, in the illustrated embodiment, the four capture axes can respectively correspond to a front view, a rear view, a left view and a right view of the object being displayed by the display panel 220. The displayed pyramid used as an example here, as shown in FIGS. 3-4, including four triangular side surfaces A, B, C, and D, respectively located at a front side, a rear side, a left side, and a right side of the pyramid. When captured from front, rear, left and right views of the pyramid, four images respectively corresponding to the surfaces A, B, C, and D can be obtained. When the display unit 212 displays the pyramid, data signals corresponding to the four images can be output to the pixels P1-P4 of the display units 212, and thereby the first pixels P1, the second pixels P2, the third pixels P3, and the fourth pixels P4 of the display units 212 are able to display the four images corresponding to the side surfaces A, B, C, and D of the pyramid respectively.

It is noted, however, that the four images are not limited to the four different views of the displayed object described. For example, in an alternative embodiment, the four images displayed by the first pixels P1, the second pixels P2, the third pixels P3, and the fourth pixels P4 of the display units 212 may correspond to a left-front view, a right-front view, a left-rear view, and a right-rear view of the object. In another alternative embodiment, the first image displayed by the first pixels P1 and the fourth image displayed by the fourth pixels P4 may both correspond to the left-front view of the displayed object, while the second images displayed by the second pixels P2 and the third image displayed by the third pixels P3 may both correspond to the right-front view of the displayed object. That is, in one embodiment, four images only corresponding to two images of an object captured from different capture axes are simultaneously displayed by the display units 212. Accordingly, in each display unit 212, the pixels (P1, P4) or (P2, P3) located in same diagonal of the sub-matrix displaying a same sub-image, and the pixels (P1, P2) or (P3, P4) located in a same row of the sub-matrix display different sub-images.

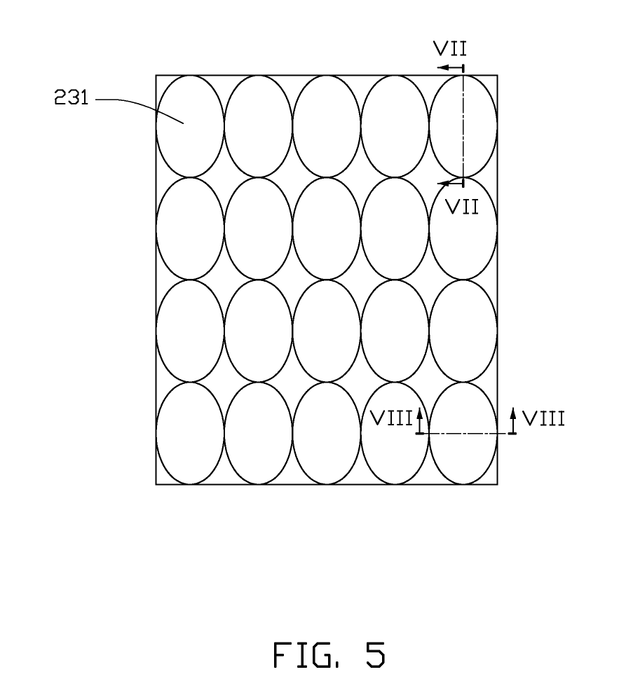

Referring also to FIG. 5, the optical film 230 includes a base (not labeled) and a plurality of lenses 231 disposed at a surface of the base. The lenses 231 are arranged in rows and columns, thereby forming a lens array. Each lens 231 corresponds to a respective display unit 212, and is located opposite to the corresponding display unit 212. A size of the lens 231 is substantially the same as that of the display unit 212, and thus the lens 231 is capable of covering the pixels P1-P4 of the display unit 212. Accordingly, light corresponding to the sub-images displayed by the pixels P1-P4 can be transmitted to the corresponding lens 231. The lens 231 is configured to refract light transmitting from pixels P1-P4 of the corresponding display unit 212, so as to select two sub-images displayed by two of the pixels P1-P4. The selected sub-images form a right image provided to the right-eye and the left image provided to a left-eye, such that the user can simultaneously view both images and experience a three-dimensional effect.

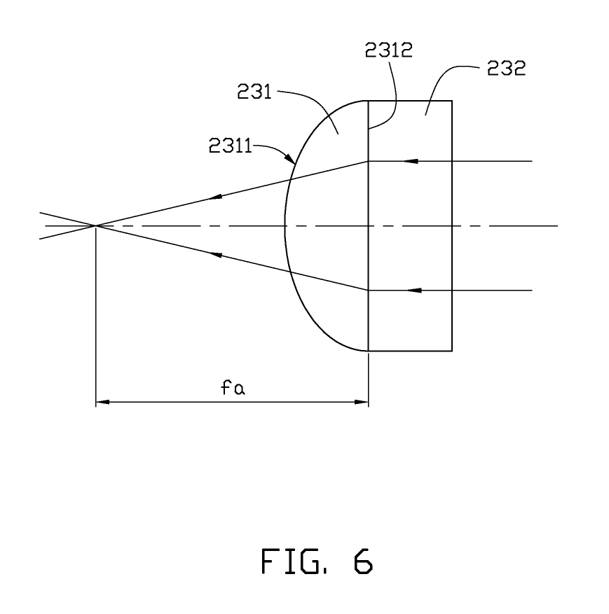

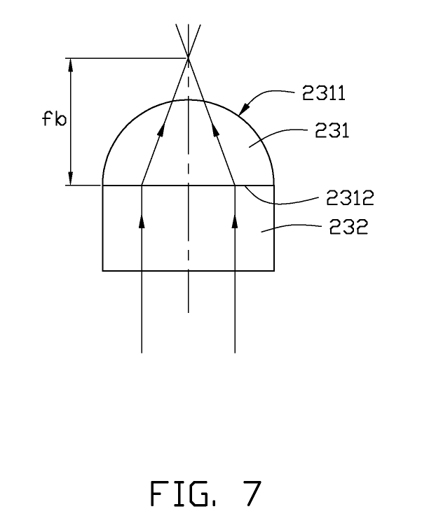

Referring also to FIGS. 6-7, each lens 231 may be a convex lens, which includes a light incident surface 2312 and a light emitting surface 2311. The light incident surface 2312 may be a flat surface directly contacting the base 232, and the light emitting surface 2311 may be a curved surface curving away from the light incident surface 2312. In the illustrated embodiment, the lens 231 has a partial ellipsoid structure, and correspondingly, light incident surface 2312 is elliptical in a planar view, and light emitting surface 2311 is convex ellipsoidal.

Due to the ellipsoidal shape of the light emitting surface 2311, a geometrical long-axis and a geometrical short-axis are defined in the light incident surface 2312 of the lens 231. In the illustrated embodiment, a proportion between the long-axis value and the short-axis value is substantially the same as an aspect ratio of the pixel P1-P4. Moreover, with the partially ellipsoidal structure, the lens 231 may further define a long focus length fa (as shown in FIG. 6) and a short focus length fb (as shown in FIG. 7), and a proportion between the long focus length fa and the short focus length fb can also be substantially the same the an aspect ratio of the pixel P1-P4.

Moreover, structural parameters such as sizes or a size or a curvature of the lens of all the lenses 231 of the optical film 230 are substantially the same. However, in alternative embodiments, the lenses 231 may have different structural parameters in accordance with the positions where the lenses 231 are located, so as to optimize stereo viewing in the three-dimensional display device 200.

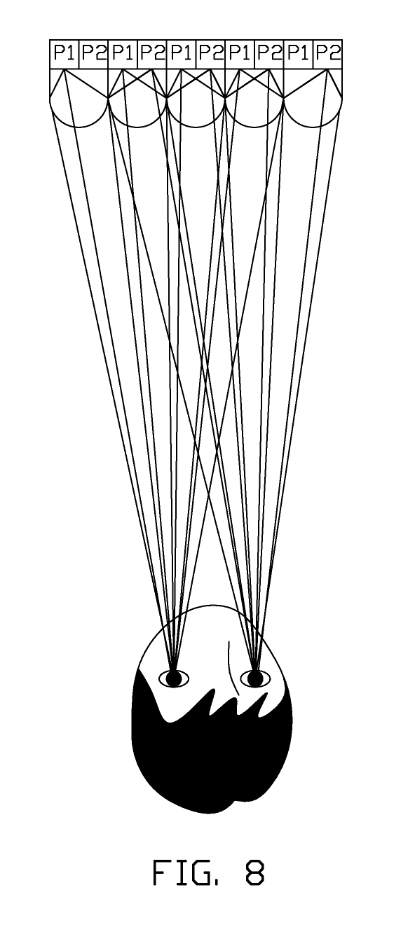

With the configuration disclosed, the three-dimensional display device 200 can provide three-dimensional effect irrespective of viewing angle. FIGS. 8-10 schematically illustrate optical routes of light from the pixels P1-P4 of the display unit 212, providing three-dimensional effect from different viewing angles.

Referring to FIG. 8, in a normal viewing situation, sight line is in front of the three-dimensional display device 200, and substantially parallel to the central horizontal line O-O of the three-dimensional display device 200, that is, an angle between the sight line and the horizontal line O-O is less than a critical angle of preset value. In this circumstance, sub-images displayed in two pixels located in a same row (P1, P2) or (P3, P4) of each display unit 212 can be viewed by both sides simultaneously, such that stereo effect is provided.

For example, when the sight line is above the central horizontal line O-O of the display device 20, as shown in FIG. 8, light corresponding to the first sub-images displayed by the first pixels P1 and light corresponding to the second sub-images displayed by the second pixels P2 is respectively diffracted by the corresponding lens 231, and converged into both viewing sides respectively. Similarly, when the sight line is below the central horizontal line O-O of the display device, light corresponding to the third sub-images displayed by the third pixels P3 and light corresponding to the fourth sub-images displayed by the fourth pixels P4 are respectively diffracted by the corresponding lens 231, and thereby converged into both viewing sides.

When the angle between the sight line and the horizontal line O-O exceeds the critical angle, three-dimensional effect is still enabled by the three-dimensional display device 200. In this circumstance, sub-images displayed in two pixels located in a same column (P1, P3) or (P2, P4) of each display unit 212 are still viewable via both viewing sides simultaneously, and stereo viewing is enabled.

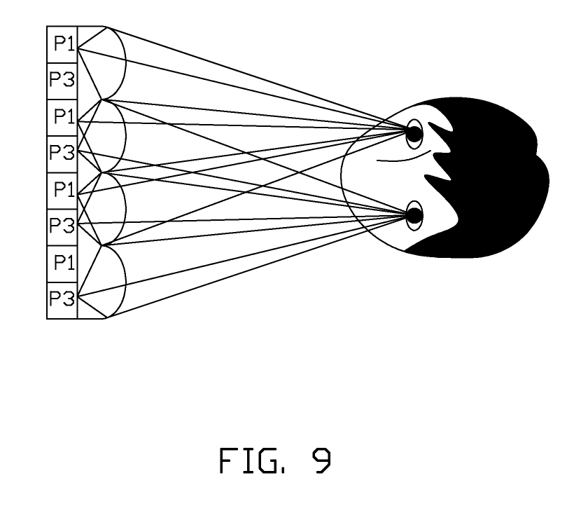

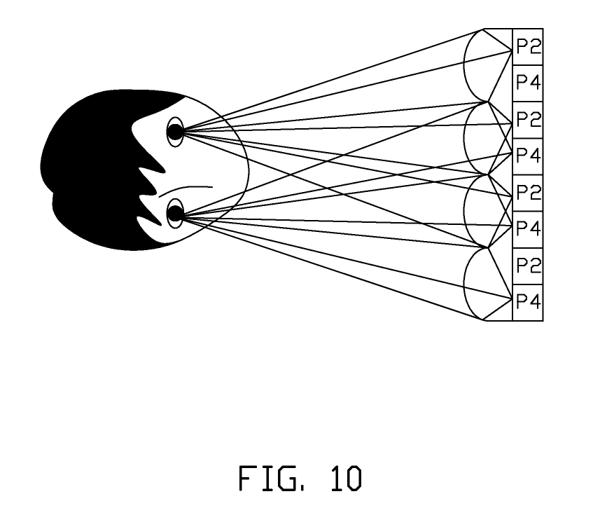

For example, when the sight line is substantially perpendicular to the horizontal line O-O, as shown in FIG. 9, light corresponding to the first sub-image displayed by the first pixels P1 and light corresponding to the third sub-image displayed by the third pixels P3 is respectively diffracted by the lenses 231, and converged into both viewing sides respectively. When, as shown in FIG. 10, light corresponding to the second sub-images displayed by the second pixels P2 and light corresponding to the fourth sub-images displayed by the fourth pixels P4 are respectively diffracted by the corresponding lens 231, and thereby being converged into the left eye and the right eye respectively.

As can be seen, by using the three-dimensional display device 200 as provided in the present disclosure, no matter which viewing angles is adopted by the user, the user can simultaneously viewed images of an object captured from two different axes, and thereby perceiving a stereo viewing of the object via the images displayed in the three-dimensional display device 200. That is, the three-dimensional display device 200 can provide three-dimensional images for the user without being limited by the viewing angles.

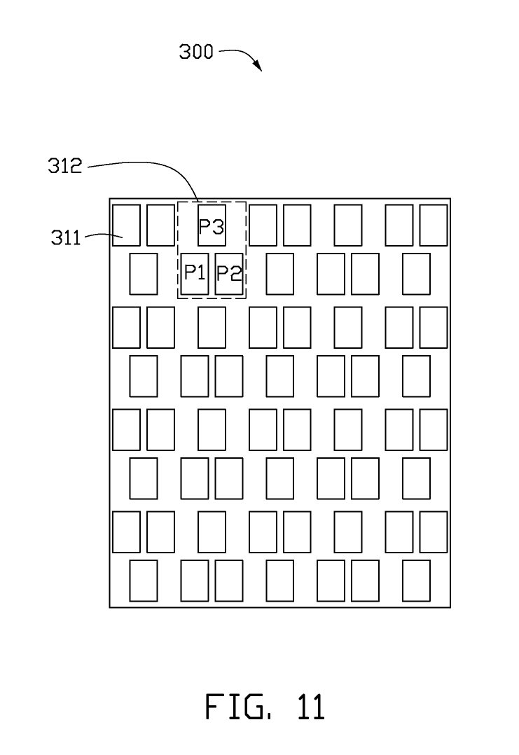

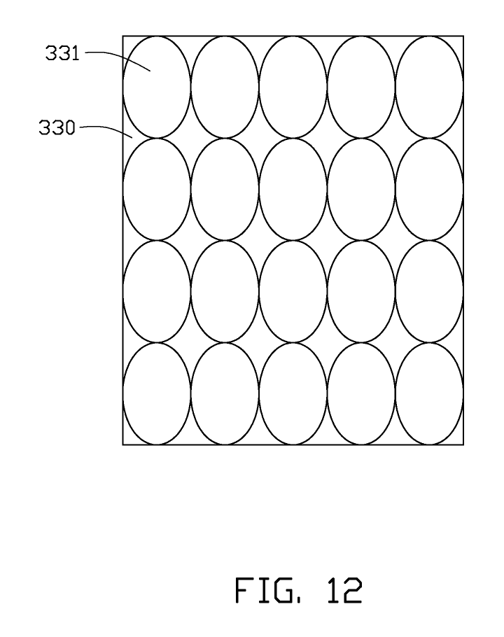

Referring to FIGS. 11-12, a display device 300 according to another embodiment of the present disclosure is shown. The display device 300 is similar to the described three-dimensional display device 200. In particular, the display device 300 includes a display panel 310 having a matrix of display units 312, each of which includes three pixels 311 distributed as an isosceles triangle. Herein, the three pixels 311 in the display unit 312 are named as P1, P2 and P3. Moreover, the display device 300 also includes an optical film 330 having a plurality of lens 331 arranged in a lens array. Each lens 331 having a structure substantially similar to the above lens 231 of the three-dimensional display device 200, and corresponds to a respective display unit 312 of the display panel 310.

Similar to the described three-dimensional display device 200, the display device 300 as defined in this embodiment can also provide three-dimensional images for the user, without being limited by the viewing angles. For example, when a user views the displayed images of the display device with his/her sight line substantially parallel to the central horizontal line of the display device 300, light corresponding to a first sub-image displayed by the first pixels P1 and light corresponding to a second sub-image displayed by the second pixels P2 are respectively diffracted by the corresponding lens 331, and being converged into the left eye and the right eye respectively. Light corresponding to the first sub-image displayed by the first pixels P1 and light corresponding to a third sub-image displayed by the third pixels P3 is respectively diffracted by the corresponding lens 331, and thereby being converged into the left eye and the right eye respectively. When the user lies down to the right while viewing the displayed images of the display device 300, light corresponding to the second sub-image displayed by the second pixels P2 and light corresponding to the third sub-image displayed by the fourth pixels P3 are respectively diffracted by the corresponding lens 331, and thereby being converged into both viewing sides respectively.

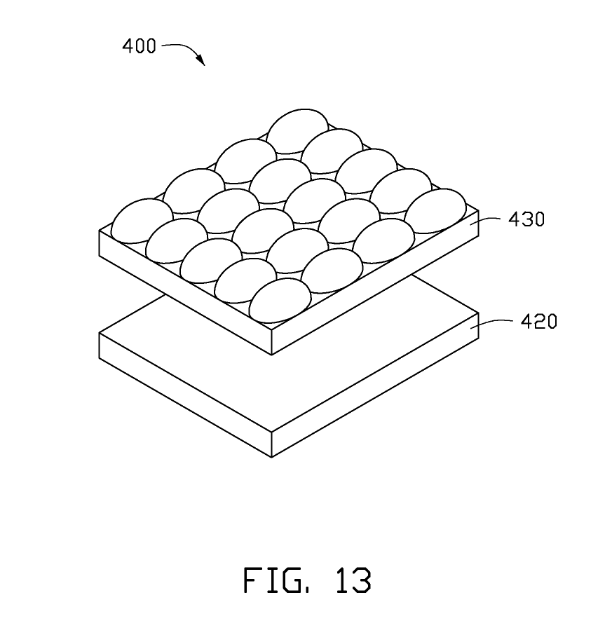

Referring to FIG. 13, a display device 400 according to another embodiment of the present disclosure is shown, differing from three-dimensional display device 200 only in that a display panel 420 of the display device 400 is an active illuminating panel, such as a plasma display panel (PDP) or an organic light emitting diode (OLED) panel, obviating the requirement for a backlight.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of present disclosure to the full extent indicated by the broad general meaning of the terms in which the appended claims are expressed.

What is claimed is:

1. A three-dimensional display device, comprising:
a display panel comprising a plurality of display units arranged in a matrix, each display unit comprising a plurality of pixels configured for displaying sub-images having stereoscopic parallax; and
an optical film disposed on the display units of the display panel and comprising a plurality of lenses, each of the lenses respectively corresponding to the display units and configured to split light emitted by the display units along a parallel axis and a vertical axis of the three-dimensional display device.

2. The three-dimensional display device of claim 1, wherein the pixels of each display unit are arranged in at least two columns, and at least two pixels of each display unit are arranged in one column.

3. The three-dimensional display device of claim 2, wherein each display unit comprises three pixels, and the three pixels are triangularly arranged.

4. The three-dimensional display device of claim 2, wherein each display unit comprises four pixels arranged in a sub-matrix having two rows and two columns.

5. The three-dimensional display device of claim 4, wherein the four pixels of each display unit are defined as a first pixel, a second pixel, a third pixel, and a fourth pixel, the sub-images displayed by the first pixels form an first image corresponding to a front view of a object, the sub-images displayed by the second pixels form an second image corresponding to a rear view of the object, the sub-images displayed by the third pixels form an third image corresponding to a left view of the object, and the sub-images displayed by the fourth pixels form an fourth image corresponding to a right view of the object.

6. The three-dimensional display device of claim 2, wherein the pixels of each display unit are covered by the corresponding lens.

7. The three-dimensional display device of claim 6, wherein each lens is a convex lens.

8. The three-dimensional display device of claim 7, wherein each lens comprises a light incident surface and a light emitting surface, the light incident surface is adjacent to the display panel, and the light emitting surface has a curved surface protruding away from the light incident surface.

9. The three-dimensional display device of claim 8, wherein the lens has a shape of part of an ellipsoid, and the light incident surface is elliptical-shaped in planar view.

10. The three-dimensional display device of claim 9, wherein the elliptical-shaped light incident surface defines a long-axis value and a short-axis value, a proportion between the long-axis value and the short-axis value is substantially the same as an aspect ratio of the pixel.

11. The three-dimensional display device of claim 9, wherein the lens defines a long focus length and a short focus length, a proportion between the long focus length and the short focus length is substantially the same as an aspect ratio of the pixel.

12. A three-dimensional display device, comprising:
a display panel comprising a plurality of display units arranged in a matrix, each display unit displaying a plurality of sub-images; and
an optical film disposed on the display panel, the optical film comprising a plurality of lenses each respectively corresponding to the display units, the lens being configured to select two sub-images displayed by the corresponding display unit, thereby the selected sub-images form a right image corresponding to a right-eye of a user and a left image corresponding to a left-eye of the user.

13. The three-dimensional display device of claim 12, wherein each display unit comprises a plurality of pixels displaying the sub-images having stereoscopic parallax, the pixels of each display unit are arranged in at least two columns, and at least two pixels of each display unit are arranged in one column.

14. The three-dimensional display device of claim 13, wherein the right image and the left image are corresponding to two pictures of an object captured from different capture axes.

15. The three-dimensional display device of claim 13, wherein each display unit comprises a first pixel, a second pixel, and a third pixel, the sub-images displayed by the first pixels form a first image, the sub-images displayed by the second pixels form a second image, the sub-images displayed by the third pixels form a third image, the first, the second, and the third images corresponding to three pictures of an object captured from different capture axes respectively, and two image of the first image, the second image, and the third image are selected as the right image and the left image.

16. The three-dimensional display device of claim 14, wherein each lens comprises a convex lens and covers the corresponding display unit.

17. The three-dimensional display device of claim 16, wherein each lens comprises a light incident surface and a light emitting surface, the light incident surface is adjacent to the display panel, and the light emitting surface has a curved surface protruding away from the light incident surface.

18. The three-dimensional display device of claim 17, wherein the lens has a shape of part of an ellipsoid, and the light incident surface is elliptical-shaped in planar view.

19. The display device of claim 18, wherein the elliptical-shaped light incident surface defines a long-axis value and a short-axis value, a proportion between the long-axis value and the short-axis value is substantially the same as an aspect ratio of the pixel.

20. The three-dimensional display device of claim 19, wherein the lens defines a long focus length and a short focus length, a proportion between the long focus length and the short focus length is substantially the same as an aspect ratio of the pixel.
